(19) United States
(12) Patent Application Publication
(10) Pub. No.: US 2014/0062129 A1
(43) Pub. Date: Mar. 6, 2014

(54) IMPACT DEFLECTION AND ABSORPTION STRUCTURE

(71) Applicants: Sajid H. Syed, Troy, MI (US); Patrick H. Clark, Troy, MI (US); Bhushan W. Dandekar, Rochester Hills, MI (US); Sigit P. Santosa, Macomb, MI (US); Jeffrey S. McCormick, Clarkston, MI (US)

(72) Inventors: Sajid H. Syed, Troy, MI (US); Patrick H. Clark, Troy, MI (US); Bhushan W. Dandekar, Rochester Hills, MI (US); Sigit P. Santosa, Macomb, MI (US); Jeffrey S. McCormick, Clarkston, MI (US)

(73) Assignee: GM GLOBAL TECHNOLOGY OPERATIONS LLC, Detroit, MI (US)

(21) Appl. No.: 13/602,418

(22) Filed: Sep. 4, 2012

(51) Int. Cl. B60R 19/26; B60R 19/24

(52) U.S. Cl. 296/187.1; 293/132

(57) ABSTRACT

An impact deflection and absorption structure for a vehicle having a vehicle body that includes a passenger compartment and an under-hood compartment. The impact deflection and absorption structure includes a frame having a frame rail configured to support the vehicle body. The impact deflection and absorption structure also includes a bumper assembly secured to the frame rail. The bumper assembly includes an impact beam arranged substantially transverse to the frame rail and a lateral member secured to the impact beam. The lateral member projects away from the impact beam and is configured to counteract impact energy that is directed substantially parallel to the frame rail into the frame rail and away from the under-hood compartment and the passenger compartment. A vehicle employing the impact deflection and absorption structure is also disclosed.

### TECHNICAL FIELD

The invention relates to a vehicle structure for deflecting and absorbing impact energy.

### BACKGROUND

A motor vehicle typically employs a robust frame for supporting the vehicle's body. The more common types of vehicle frames are a full frame, a unibody, and a sub-frame. A full frame is generally a distinct structure that provides a mounting base for the vehicle body, while a unibody is typically formed by integrating frame sections with the vehicle body. A sub-frame is usually a stand-alone structure mounted to the unibody for supporting a specific vehicle subsystem, such as a powerplant.

Typically, vehicles employ additional structural components, such as bumpers, designed to allow the vehicle to withstand some level of impact without sustaining extensive damage to the vehicle's body or its safety systems. Such additional components are typically tied to the vehicle frame to allow the frame to absorb a significant portion of impact energy and, for occupant protection, route the energy away from the vehicle's passenger or occupant compartment.

### SUMMARY

An impact deflection and absorption structure is disclosed for a vehicle. The vehicle includes a body having a passenger compartment and an under-hood compartment. The impact deflection and absorption structure includes a frame having a frame rail configured to support the vehicle body. The impact deflection and absorption structure also includes a bumper assembly secured to the frame rail. The bumper assembly includes an impact beam arranged substantially transverse to the frame rail and a lateral member secured to the impact beam. The lateral member projects away from the impact beam and is configured to counteract, i.e., redirect, deflect, and/or guide, impact energy that is directed substantially parallel to the frame rail into the frame rail and away from the under-hood compartment and the passenger compartment.

The lateral member may include an outer surface. The outer surface may be arranged at an angle with respect to the frame rail and configured to transfer the impact energy into the frame rail. Additionally, the outer surface being arranged at an angle with respect to the frame rail may transfer the impact energy into an un-impacted portion of the impact deflection and absorption structure through components of the bumper assembly, for example through the impact beam.

The angle of the outer surface with respect to the frame rail may be in the range of 10-60 degrees.

The lateral member may be constructed from steel. The lateral member may also be constructed from aluminum alloy.

The lateral member may additionally be secured to the frame rail.

The lateral member may be welded to at least one of the impact beam and the frame rail.

The lateral member may be fastened to at least one of the impact beam and the frame rail.

The lateral member may define a hollow space configured to reduce mass of the lateral member.

The lateral member may be configured as a cantilevered structural member having a width, height, and depth. The depth may have a magnitude that is either substantially equivalent to or greater than the width.

A vehicle employing the above-described impact deflection and absorption structure is also disclosed.

The above features and advantages, and other features and advantages of the present disclosure, will be readily apparent from the following detailed description of the embodiment(s) and best mode(s) for carrying out the described invention when taken in connection with the accompanying drawings and appended claims.

### BRIEF DESCRIPTION OF THE DRAWINGS

FIG. 1 is a schematic top view of a vehicle including an impact deflection and absorption structure shown in phantom.

FIG. 2 is a partial schematic close-up bottom view of the vehicle with impact deflection and absorption structure shown in FIG. 1.

FIG. 3 is a partial schematic bottom perspective view of the impact deflection and absorption structure shown in FIG. 2.

### DETAILED DESCRIPTION

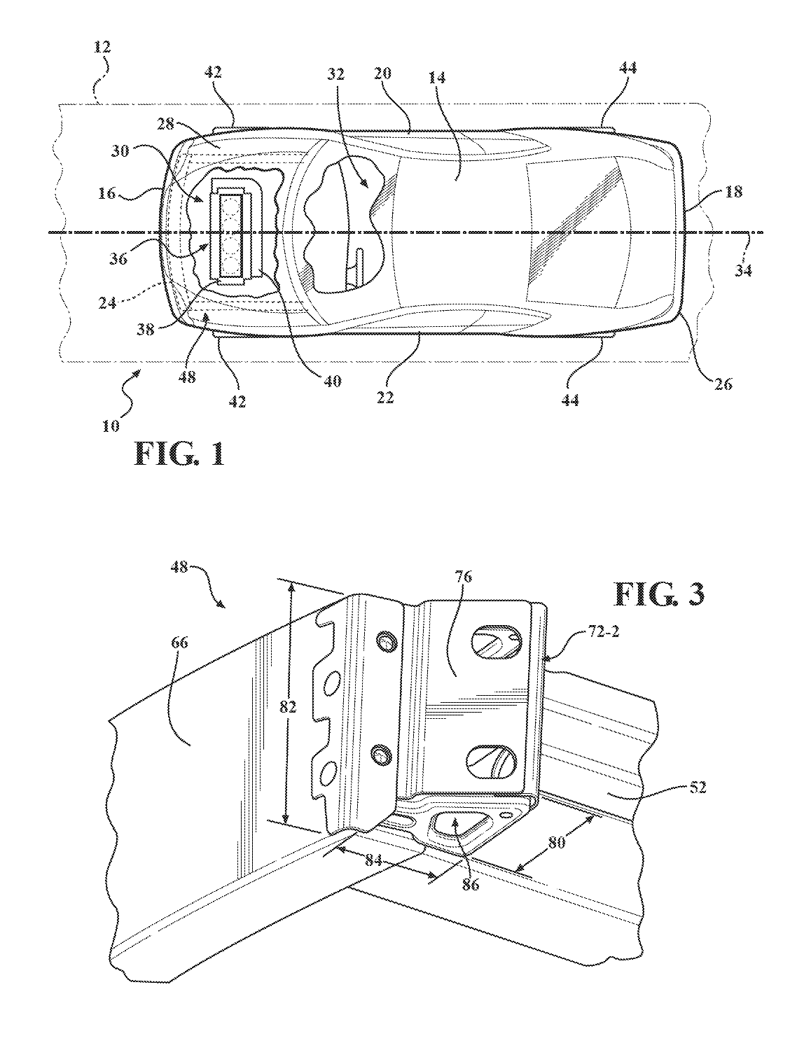

Referring to the drawings, wherein like reference numbers refer to like components, FIG. 1 shows a schematic view of a motor vehicle 10 positioned relative to a road surface 12. The vehicle 10 includes a vehicle body 14. The vehicle body 14 defines four body sides. The four body sides include a first or front end 16, a second or rear end 18, a right side 20, and a left side 22, all of which are characterized by exterior panels or surfaces. As shown, the front end 16 may include a front bumper assembly 24, while the rear end 18 may include a rear bumper assembly 26. As defined herein, the bumper assemblies 24 and 26 are inner structures that are covered by exterior panels of the body sides 16, 18, 20, and 22.

An outer corner is defined where one of the body sides 16, 18, 20, and 22 joins another body side on the exterior surface of the vehicle body 14. Specifically, the front end 16 joining the right side 20 defines an outer corner 16-1, the front end 16 joining the left side 22 defines an outer corner 16-2, the rear end 18 joining the right side 20 defines an outer corner 16-3, and the rear end 18 joining the left side 22 defines an outer corner 16-4. The vehicle body 14 also includes a hood 28 configured to cover at least a portion of the front end 16 to thereby define an under-hood compartment 30. The vehicle body 14 also defines a passenger or occupant compartment 32 positioned between the under-hood compartment 30 and the rear end 18. A longitudinal centerline 34 extends through the vehicle body 14, from the front end 16 to the rear end 18.

The under-hood compartment 30 houses a powertrain 36 that is configured to propel the vehicle 10. As shown in FIG. 1, the powertrain 36 may include an internal combustion (IC) engine 38 and a transmission 40. The powertrain 36 may also include one or more motor/generators as well as a fuel cell, neither of which are shown, but a powertrain configuration employing such devices is appreciated by those skilled in the art. The vehicle 10 also includes front wheels 42 and rear wheels 44. Depending on specific configuration of the powertrain 36, power of the engine 38 may be transmitted to the road surface 12 through the front wheels 42, the rear wheels 44, or through all the wheels 42 and 44 using a suspension system 46.

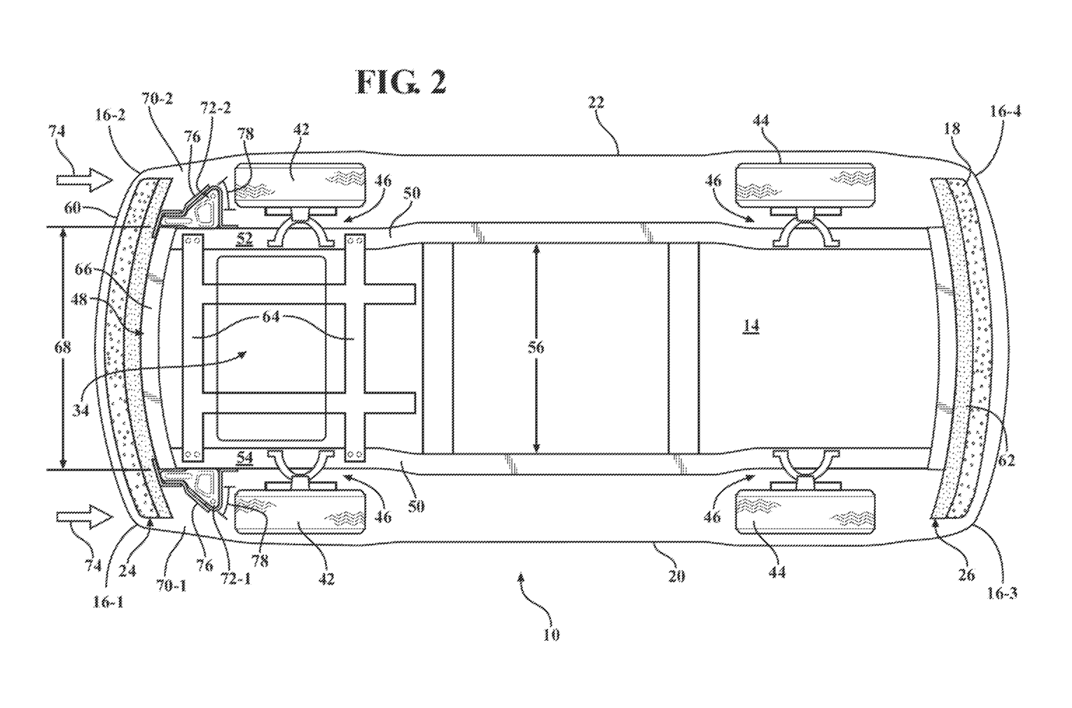

As shown in phantom in FIG. 1, the vehicle 10 also includes an impact deflection and absorption structure 48. As may be seen in FIG. 2, the structure 48 includes a frame 50 having frame rails 52, 54 configured to support the vehicle body 14, the powertrain 36, and the vehicle suspension system 46. The frame rails 52, 54 are positioned apart in the vehicle 10 by a distance 56 and extend longitudinally with respect to the vehicle body 14. The frame rails 52, 54 may extend substantially from the front end 16 to the rear end 18 in a full-frame vehicle depicted in FIG. 1, i.e., for the majority of the length of the vehicle body 14. As understood by those skilled in the art, in a unibody-type vehicle (not shown), the frame rails 52, 54 may extend only part of the way from the front end 16 to the rear end 18, and another set of frame rails may extend longitudinally for some distance to the rear end 18.

The structure 48 also includes a bumper assembly 24 secured to the frame rails 52, 54. The bumper assembly 24 is substantially enclosed by the front end 16 of the vehicle body 14, such as by a specifically styled bumper cover 60. The structure 48 additionally includes the bumper assembly 26 secured to the frame rails 52, 54 and substantially enclosed by the rear end 18 of the vehicle body 14, such as by a specifically styled bumper cover 62. The structure 48 may additionally include intermediate frame rails 64 positioned between the front end 16 and the rear end 18 of the vehicle body 14. Such intermediate frame rails 64 may be positioned to span the distance between frame rails 52 and 54, cross-wise or transverse relative to the vehicle body 14 in order to further stiffen the vehicle structure and support the powertrain 36.

The bumper assembly 24 includes the impact beam 66 having a length 68. The impact beam 66 is arranged substantially transverse to the frame rails 52, 54, e.g., less than +/−5 degrees. The length 68 and positioning of the impact beam 66 transverse to the frame rails 52, 54 permits a space 70-1 to be generated on the right side 20 of the front end 16 between the impact beam 66 and the outer corner 16-1. Similarly, a space 70-2 is generated on the left 22 side of the front end 16 and the outer corner 16-2. As shown, the bumper assembly 24 also includes two lateral members 72-1 and 72-2. The lateral members 72-1, 72-2 are configured to provide a reinforced structure in conjunction with frame rails 52, 54 and the bumper assembly 24 to withstand the energy of an impact 74 on the vehicle 10 that is offset from the centerline 34.

The offset impact 74 is distinct from other types of frontal impact in that the subject impact is directed into the region of the outer corner 16-1 or 16-2, and the lateral member 72-1 or 72-2, respectively, counteracts the impact by at least partially filling the spaces 70-1, 70-2. The lateral members 72-1 and 72-2 are configured to counteract energy of the impact 74 by redirecting and guiding the force of the impact into the frame rails 52, 54. Also, depending on the precise point of contact and the angle of the impact 74 relative to the body 14, the lateral members 72-1 and 72-2 may also deflect the impact away from the frame rails 52, 54 and the passenger compartment 32.

Each of the lateral members 72-1 and 72-2 may be characterized by a wedge shape having an angled outer surface 76, as shown in FIG. 2. As shown, the outer surface 76 is proximate to the front end 16 and is arranged obliquely, i.e., at an angle 78 with respect to the pertinent frame rail 52 or 54. The angle 78 of the outer surface 76 with respect to the subject frame rail 52 or 54 may be in the range of approximately 10-60 degrees. The lateral members 72-1 and 72-2 may be constructed from a suitable high strength material such as steel or aluminum alloy. As shown, the lateral members 72-1 and 72-2 are configured as cantilevered structural members having a width 80, height 82, and depth 84.

As shown in FIG. 3, the width 80 and height 82 are selected to fill the appropriate space 70-1, 70-2 in the concomitant corner 16-1, 16-2, while the depth 84 is selected to appropriately distribute the force of the offset impact 74 into the respective frame rail 52 or 54. The depth 84 may have a magnitude that is substantially equivalent or greater than the width 80 for structural stability of the subject lateral member 72-1, 72-2 during the offset impact 74. In the instant case, the term “substantially” may mean that the magnitude of the depth 84 is at least 80% of the magnitude of the width 80. As may be seen in FIGS. 2 and 3, each lateral member 72-1, 72-2 may also define a hollow space 86. The hollow space 86 may be provided to reduce mass of the subject lateral member 72-1, 72-2.

One lateral member 72-1 is secured to the impact beam 66 such that the lateral member extends beyond a boundary of the impact beam into the space 70-1 between the impact beam and the outer corner 16-1. The other lateral member 72-2 is secured to the impact beam 66 such that the lateral member extends beyond a boundary of the impact beam into the space 70-2 between the impact beam and the outer corner 16-2. Accordingly, each lateral member 72-1 and 72-2 is configured to counteract impact energy that is directed into the respective space 70-1 and 70-2. Each lateral member 72-1 and 72-2 may additionally be secured to the respective frame rail 52 or 54. Each lateral member 72-1, 72-2 may be welded to its respective frame rail 52 or 54 and to the impact beam 66. Alternatively, each lateral member 72-1, 72-2 may be fastened to its respective frame rail 52 or 54 and to the impact beam 66 via an appropriate device, such as a rivet or a bolt and a nut. A hybrid welded and fastened lateral member 72-1, 72-2, such as the member 72-2 that is shown in FIG. 3, is also envisioned.

With resumed reference to FIG. 2, the vehicle 10 may be subjected to the impact 74 that is directed at or into the respective space 70-1 or 70-2 substantially parallel to the frame rails 52, 54. In the absence of the pertinent lateral member 72-1 or 72-2, such an offset impact may intrude into the under-hood compartment 30, damage the suspension system 46, and dislocate the powertrain 36 into the passenger compartment 32. The lateral members 72-1 and 72-2 may redirect, transfer, or guide the energy of the offset impact 74 into the bumper assembly 24 and the frame rails 52 and/or 54, and away from the under-hood compartment 30 and the passenger compartment 32. The outer surface 76 being arranged at the angle 78 with respect to the subject frame rail 52, 54 may transfer the impact energy into the un-impacted portion of the impact deflection and absorption structure 48. The un-impacted portion of the impact deflection and absorption structure 48 may include the other, i.e., un-impacted, frame rail 52 or 54, while the energy may be transferred through components of the bumper assembly 24, such as through the impact beam 66. Furthermore, depending on the exact direction and force of the offset impact 74, the lateral members 72-1 and 72-2 may also deflect the offset impact due to the nature of their wedge shape and the angled outer surface 76.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A vehicle comprising:
a vehicle body having a first end, two body sides, and a second end, wherein the first end and one of the two body sides defines an outer corner of the vehicle body; and
an impact deflection and absorption structure having:
a frame having a frame rail configured to support the vehicle body; and
a bumper assembly secured to the frame rail and substantially enclosed by the first end of the vehicle body, the bumper assembly having:
an impact beam arranged substantially transverse to the frame rail, such that a space is generated between the impact beam and the outer corner of the vehicle body; and
a lateral member secured to the impact beam such that the lateral member extends into the space between the impact beam and the outer corner of the vehicle body and configured to counteract impact energy that is directed into the space between the impact beam and the outer corner of the vehicle body.

2. The vehicle of claim 1, further comprising a powertrain, wherein:
the vehicle body additionally includes:
a hood configured to cover at least a portion of the first end of the body to thereby define an under-hood compartment, wherein the powertrain is positioned substantially in the under-hood compartment; and
a passenger compartment positioned between the under-hood compartment and the second end; and
the lateral member is additionally configured to redirect the impact energy that is directed at the space between the impact beam and the outer corner of the vehicle body substantially parallel to the frame rail into the frame rail and away from the under-hood compartment and the passenger compartment.

3. The vehicle of claim 2, wherein the lateral member includes an outer surface proximate to the first end of the vehicle body, and wherein the outer surface is arranged at an angle with respect to the frame rail and configured to transfer the impact energy into the frame rail.

4. The vehicle of claim 3, wherein the angle of the outer surface with respect to the frame rail is in the range of 10-60 degrees.

5. The vehicle of claim 1, wherein the lateral member is constructed from steel.

6. The vehicle of claim 1, wherein the lateral member is constructed from aluminum alloy.

7. The vehicle of claim 1, wherein the lateral member is additionally secured to the frame rail.

8. The vehicle of claim 7, wherein the lateral member is welded to at least one of the impact beam and the frame rail.

9. The vehicle of claim 7, wherein the lateral member is fastened to at least one of the impact beam and the frame rail.

10. The vehicle of claim 1, wherein the lateral member defines a hollow space configured to reduce mass of the lateral member.

11. An impact deflection and absorption structure for a vehicle having a vehicle body including a passenger compartment and an under-hood compartment, the impact deflection and absorption structure comprising:
a frame having a frame rail configured to support the vehicle body; and
a bumper assembly secured to the frame rail, the bumper assembly having:
an impact beam arranged substantially transverse to the frame rail; and
a lateral member secured to the impact beam such that the lateral member projects away from the impact beam and is configured to counteract impact energy that is directed substantially parallel to the frame rail into the frame rail and away from the under-hood compartment and the passenger compartment.

12. The impact deflection and absorption structure of claim 11, wherein the lateral member includes an outer surface, and wherein the outer surface is arranged at an angle with respect to the frame rail and configured to transfer the impact energy into the frame rail.

13. The impact deflection and absorption structure of claim 12, wherein the angle of the outer surface with respect to the frame rail is in the range of 10-60 degrees.

14. The impact deflection and absorption structure of claim 11, wherein the lateral member is constructed from steel.

15. The impact deflection and absorption structure of claim 11, wherein the lateral member is constructed from aluminum alloy.

16. The impact deflection and absorption structure of claim 11, wherein the lateral member is additionally secured to the frame rail.

17. The impact deflection and absorption structure of claim 16, wherein the lateral member is welded to at least one of the impact beam and the frame rail.

18. The impact deflection and absorption structure of claim 16, wherein the lateral member is fastened to at least one of the impact beam and the frame rail.

19. The impact deflection and absorption structure of claim 11, wherein the lateral member defines a hollow space configured to reduce mass of the lateral member.

20. The impact deflection and absorption structure of claim 11, wherein the lateral member is configured as a cantilevered structural member having a width, height, and depth, and wherein the depth has a magnitude that is one of substantially equivalent and greater than the width.
